(19) United States
(12) Patent Application Publication
(10) Pub. No.: US 2018/0279803 A1
(43) Pub. Date: Oct. 4, 2018

(54) SAFETY SEAT, NOTABLY FOR A CHILD

(71) Applicant: BLUEBEEP, Male (FR)

(72) Inventors: Laurent BAILLIARD, Paris (FR); Louis Pascal DEVELAY, Male (FR); Patrick HERBAULT, La Garenne Colombes (FR); Edouard DUPONT-MADINIER, Neuilly sur Seine (FR)

(73) Assignee: BLUEBEEP, Male (FR)

(21) Appl. No.: 15/758,889

(22) PCT Filed: Sep. 8, 2016
(86) PCT No.: PCT/EP2016/071218

§ 371 Date: Mar. 9, 2018

(30) Foreign Application Priority Data
Sep. 9, 2015 (FR) 15/01869

(51) Int. Cl. A47D 15/00; B60N 2/26; B60R 22/10; B60R 22/48

(52) U.S. Cl. CPC A47D 15/006; B60N 2/265; B60R 2022/4808; B60R 22/48; B60R 22/105

(57) ABSTRACT

A safety seat of the type having a seat part that is kept at a distance from the ground by a support system. The seat includes a detection system and signalling system, the latter being able to go off when it is shaken and/or unintentionally inclined.

The present invention relates to a safety seat, notably a seat for a child, such as for example a high-chair type seat, a deck-chair seat, a swing seat or a bicycle seat, etc.

It is known that one of the main causes of domestic accidents is children falling following incorrect use of a high-chair.

Prominent among these are accidents occurring on account of the chair tipping over and those occurring on account of the child falling therefrom.

The existence has been noted of serious accidents which occur following a child chair tipping over caused for example by unintentional shaking of the latter, or by the fact that the child has violently pushed back its high-chair by shoving for example against a nearby table. The accidental tipping over of the high-chair may also take place further to a clumsy attempt by the child to climb onto it alone.

These accidents may also occur when a child purely and simply falls from a high-chair. That is why it has been proposed to equip safety seats with means for retaining the person. It is known that the retaining means that equip safety seats, and notably seats for children, normally comprise a belt or a harness which is provided with several attachment points, notably three or five points, which engage with a locking buckle which ensures the solid attachment of the harness with the person of whom it is wished to ensure the retaining and the safety.

More specifically, these harnesses generally comprise, when they are of the so-called three-point type, two ventral straps and a crotch strap and, when they are the five-point type, two ventral straps, a crotch strap and two shoulder straps, the crotch strap receiving the locking buckle.

It has however been noted that these retaining means are not sufficiently efficient to prevent accidental falls. Such falls usually occur when the child has succeeded in detaching itself from the retaining harness, and when it has got out of its high-chair without the locking buckle being undone.

It will be understood that correct retaining of the individual can only be ensured if the straps are made integral with the locking buckle and that is why, in the prior art, various means have been proposed making it possible to check the correct state of this locking.

Simple devices have thus been proposed in the field of high-chairs for children, notably by the patent FR 2.861.025, which simply seek to check whether the locking buckle is correctly locked and, in the hypothesis where this is not the case, to emit an audible signal for the attention of the people around the child.

Such devices do not directly meet the needs linked to this type of seat in so far as it is necessary to leave the child a certain mobility allowing it to play, to eat, etc., to the extent that it can perfectly unstrap itself while conserving the locking buckle in the locked state. Furthermore, when the child is not present on the seat it is, except in particular cases mentioned hereafter, pointless to set off an alert if the locking buckle is not unlocked.

For this reason it has been proposed to equip certain seats with a presence sensor, but in so far as the problem of the release of the child from its retaining harness without the locking buckle being unlocked is not resolved, this sensor turns out to be totally inefficient.

A high-chair has also been proposed, in the patent application US 2001/048372, equipped with a device making it possible to set off an alarm when it is subjected to an inclination, the value of which exceeds a determined threshold value. Such a device is not able to ensure effective safety from the moment that the time existing between setting off the alarm and the tipping over of the chair is not generally sufficient to enable an intervention preventing the fall thereof.

The aim of the present invention is to propose a safety seat, notably for a child, which is able not only to check continually for the presence of a person on the seat, that the stability of the seat is ensured and that the means for retaining the occupant on the seat are indeed operational, but also to detect the first signs of a tipping over and fall of the chair which enables an intervention preventing the latter and to do so whether the child is or not in position thereon.

The present invention thus relates to a safety seat comprising a seat base that is kept at a distance from the ground by support means, characterized in that it comprises detection means and signalling means, the latter signalling means being able to go off when said seat is shaken and/or unintentionally inclined. Notably, the signalling means are able to go off when said seat is shaken above a threshold level.

According to the invention the detection and signalling means could be in relation with a central system that will manage the values read by the latter, this central system being able to comprise a microcontroller and/or a microprocessor.

The detection means could include at least one accelerometer, notably of three-dimensional type. The seat could include means suitable for making the accelerometer carry out, with a given frequency, a series of measurements of the acceleration undergone by said seat, along the measurement axes of the accelerometer. It could also include means suitable for calculating, for each of the measurement axes, an average acceleration value.

The central system could comprise means suitable for comparing the components of the acceleration value supplied by the accelerometer with a threshold value, and means suitable for activating the signalling means when this value becomes at least equal to said threshold value.

The detection means could include at least one capacitive sensor. This capacitive sensor will be arranged in such a way that it is able to detect on the one hand the presence of an occupant on the seat and on the other hand a modification of the position of the occupant thereon.

Furthermore, the detection means could include at least one inclinometer and the central system could comprise means suitable for comparing the inclination value supplied by this inclinometer with at least one threshold value and means suitable for activating the signalling means when this value becomes at least equal to said threshold value.

The signalling means could be of audio type, such as notably a vibrator or a buzzer and/or of luminous type such as notably a flash or a LED and/or of electronic type implementing transmission means of Bluetooth type, notably low energy, to any apparatus compatible with this technology such as notably a smartphone and/or a computer and/or an autonomous loudspeaker and/or a television.

The safety seat could comprise means for retaining an occupant on the seat, constituted of a harness provided with at least one lateral strap and one crotch strap of which a first end terminates by a locking buckle with at least one lateral strap, characterized in that the second end of the crotch strap passes through the seat base via a passage opening and extends by return means suitable for exerting a return force thereon tending to apply the buckle against the seat base.

These return means could be constituted of an elastic strap element made integral with the crotch strap at one of its ends and a point for attaching the seat at its other end.

The seat could comprise, near to the passage opening, a proximity sensor of the buckle able to detect the presence thereof when it is applied against the seat base under the action of the return means.

Embodiments of the present invention will be described hereafter, as non-limiting examples, with reference to the appended drawing, in which:

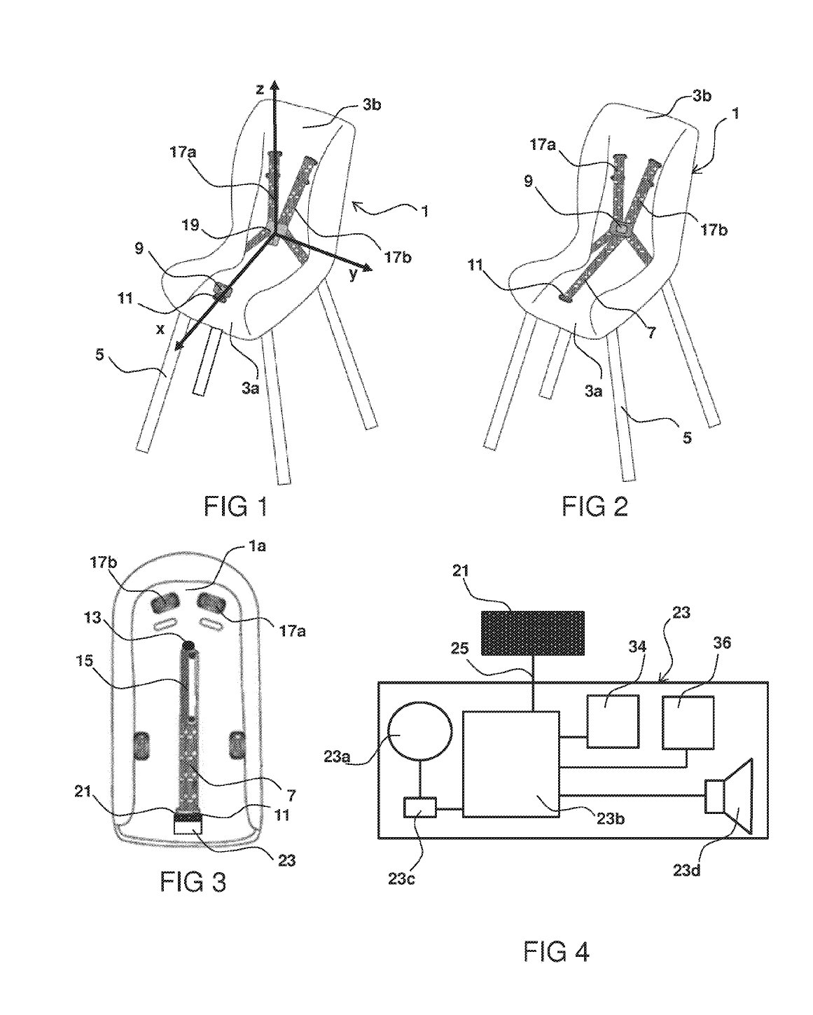

FIG. 1 is a perspective view of a safety seat for a child according to the invention in non-locking position,

FIG. 2 is a perspective view of the safety seat for a child represented in FIG. 1 in locking position,

FIG. 3 is a rear view of the safety seat for child represented in FIGS. 1 and 2,

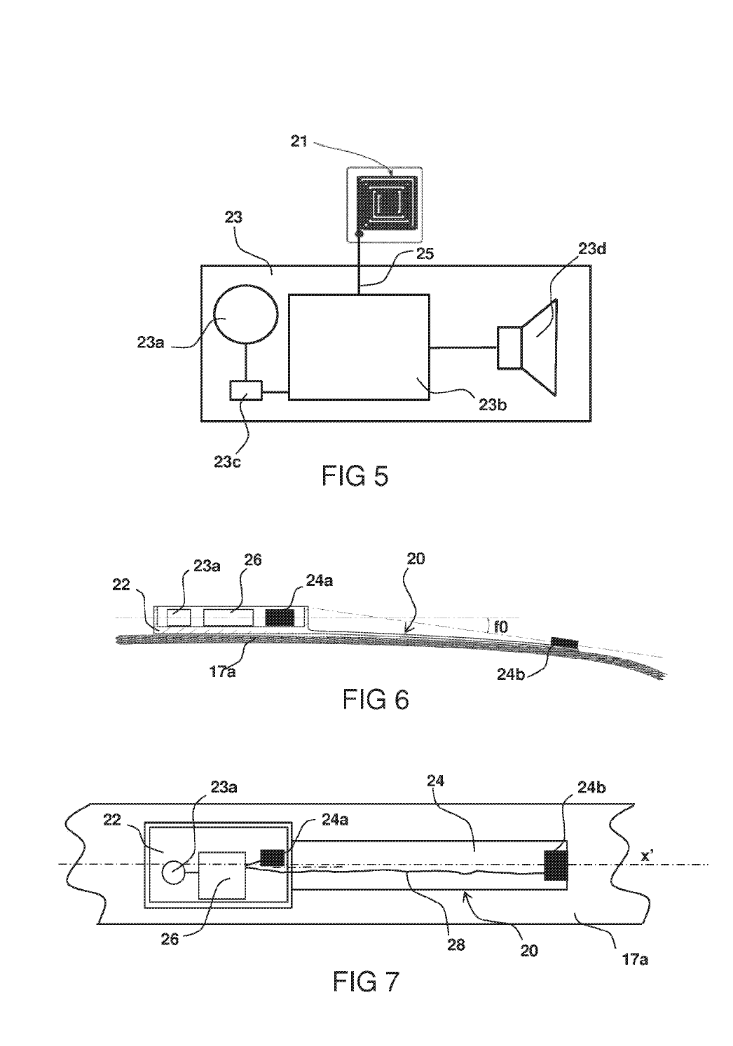

FIGS. 4 and 5 are schematic views of two examples of electronic logics implemented according to the present invention,

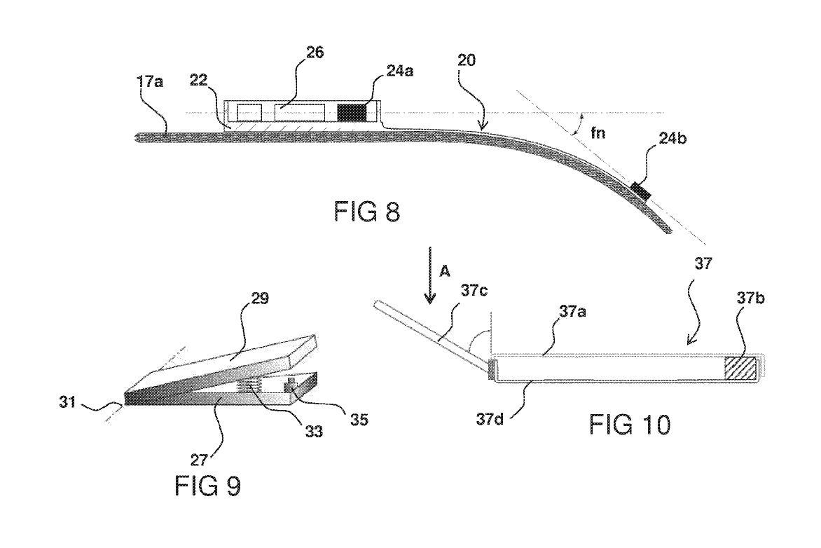

FIGS. 6 and 8 are transversal sectional views of an embodiment of a bending sensor respectively before and after bending of the retaining strap on which it is arranged,

FIG. 7 is a top view of the bending sensor represented in FIGS. 6 and 8,

FIG. 9 is a schematic view of a mechanical presence sensor of a person on the seat,

FIG. 10 is a schematic view of an electronic presence sensor of a person on the seat,

In FIGS. 1 to 3 is represented a safety seat 1, intended to receive an occupant and notably a child, forming a high-chair. This high-chair includes a seat base 3a and a backrest 3b which are kept at a desired distance from the ground by four feet 5.

According to the invention this high-chair comprises means that are capable on the one hand of controlling the correct retaining of an occupant thereon by means of a harness and on the other hand of detecting events that constitute the first signs of a fall of the high-chair so as to enable an intervention making it possible to prevent said fall.

The means for detecting the first signs of a fall will act on two levels, on the one hand at the level of the detection of shaking manifested by the occupant of the high-chair, and on the other hand at the level of an inclination thereof which, normally, follows the shaking and which precedes by little the fall.

This thus explains the interest of measuring a shaking level which, when associated with the absence of detection of a change in inclination, makes it possible to set off in advance an alert without awaiting the start of the actual tipping over of the high-chair.

As regards the retaining means, the seat 1 comprises a harness which mainly includes a first central strap 7, designated crotch strap, which at one of its ends comprises a locking buckle 9, and which passes through the seat base 3a via an opening 10 to be attached, by its other end, to the upper part of the back of the backrest 3b, at an attachment point 13 with interposition of an elastic return strap 15. Thus, in the absence of any applied force, when the seat is in rest position, and as represented in FIG. 1, the return strap 15 applies the locking buckle 9 against the opening 11.

The retaining harness also includes two lateral straps 17a and 17b which are arranged symmetrically with respect to the backrest 3b. The ends of each of these two straps 17a and 17b pass through the upper part of the backrest 3b and the seat base 3a to be attached to the back of these two elements. Furthermore, these two straps are joined together on a clasp 19 suitable for engaging with complementary means of the locking buckle 9, in such a way as to be able to be locked therein in position of immobilisation of an occupant on the high-chair 1, as represented in FIG. 2.

On the back la of the high-chair 1 is arranged, near to the opening 11, a sensor 21 suitable for detecting the presence of the locking buckle 9 when the latter is applied against the opening 11 under the effect of the traction that is applied thereto by the elastic return strap 15, as represented in FIG. 1.

The presence sensor 21 of the locking buckle 9 is connected to an electronic logic arranged in a casing 23. This electronic logic includes a power supply battery 23a, notably a lithium battery, which supplies a microcontroller or a microprocessor 23b which is in relation, by wired connection means 25, with the buckle sensor 21. A switch 23c makes it possible to command the powering on of the device and a buzzer 23d commanded by the microcontroller 23b makes it possible to signal any critical situation. This casing 23 may be placed for example under the seat base 3a of the high-chair, substantially at the centre thereof, so as to be out of reach of the occupant.

In these conditions the safety seat 1 according to the invention functions in the manner described hereafter. In the rest state the harness of the high-chair 1 is in the position represented in FIG. 1, that is to say when the elastic return strap 15 applies the locking buckle 9 against the opening 11 and when the switch 23c is in open position, with the result that the command electronic contained in the casing 23 is not activated and the alarm is consequently inoperative.

The user of the high-chair sets down the occupant, for example a child, thereon and buckles the harness by introducing the clasps 19 into the locking buckle 9. To do so, the user exerts traction on the crotch strap 7 counter to the return force exerted by the elastic return strap 15. The user then activates the command electronic by switching the switch 23c to the “ON” position. The microcontroller 23b can then acknowledge receipt of the activation by commanding the generation of an audible signal via the buzzer 23d for the attention of the user who then has confirmation that the system is indeed operational.

It is understood that in this position of retaining the child, and as long as the child maintains a position that does not release the locking buckle 9, the position sensor 21 of the buckle 9 does not detect it in so far as it is too far away.

If, during the journey, the child totally or partially frees itself from the harness, then the elastic return strap 15, on account of the tractive force that it exerts on the locking buckle 9, brings it back against the opening 11, thus within the reception range of the buckle presence sensor 21, and the latter then sends a signal to the microcontroller 23b. On reception, the microcontroller 23b then sets off, for the attention of the user, an alarm by means of the buzzer 23d. The user is thus warned that the child has become partially unstrapped and can then intervene.

The means for detecting the presence of the locking buckle 9 may be of very diverse types.

Thus they may for example be constituted of a passive antenna of “RFID tag” type which is arranged on the locking buckle 9 and which will be detected by appropriate complementary means of the sensor 21. They may also be constituted of a magnet or a magnetised part of the buckle which will close an electrical circuit via an ILS type device or a Hall effect detector of the sensor 21.

Obviously, according to the invention, resort could be made to any other means making it possible to control the correct retaining of the child on the seat and notably a device implementing the control of a correct state of bending of at least one of the retaining straps. It has been noted in fact that, notably at the level of the shoulder of the child, the curvature is not the same when it is unstrapped as when it is correctly strapped in.

In such an exemplary embodiment, represented in FIGS. 6 to 8, the control device includes a detector 20 which is situated in the extension of a casing 22 and comprises a flexible and deformable tongue 24, for example made of a compound of polyamide, polyether, polyester, isocyanate, etc. This tongue has however sufficient rigidity so that, in the absence of applied force, it is able to recover its rectilinear shape as represented in FIG. 6.

The casing 22 and the detector 20 comprise two accelerometers 24a and 24b which are provided, in a known manner, with an inclinometer function that is going to be used in the present case. The first inclinometer 24a is arranged in the casing 22 and is connected to a microcontroller 23b. The second inclinometer 24b is arranged for its part at the free end of the tongue 24 and is connected to the microcontroller 23b by a wire link 28. Thus the microcontroller 23b is able to determine easily the bending value f of the detector, and thus that of the lateral retaining strap 17a, 17b on which it is mounted, by the simple difference in the values delivered by the two inclinometers. The microcontroller 23b compares this value f with a threshold value fs and if it is higher it deduces therefrom that the curvature is sufficient so that the child is correctly strapped in and, conversely, if it is lower it deduces therefrom that the child has detached itself and emits a warning signal for the attention of the user.

In another exemplary embodiment of the present invention the high-chair 1 is provided with means making it possible to detect the presence of a child thereon, these means being in relation with the microcontroller 23b.

The detection means as well as the means for communicating with the microcontroller 23b may also be of very diverse types. These means may, in a non-limiting manner, be for example of mechanical type such as notably a pressure or weight sensor, of electronic type such as notably with photoelectric cell, with strain gauge or of capacitive type.

Resort may thus be made to mechanical type presence sensors, as represented in FIG. 9. Such a sensor, which is for example arranged in a cushion arranged on the seat base 3a of the high-chair, may be constituted of a plate 27 on which a feeler 29 is rotationally mounted around an axis 31 and which, in the absence of stress, is positioned in a high position by a compression spring 33. A contactor 35 is arranged on the plate 27 in such a way that, when the feeler 29 is in low position, it is activated.

It will thus be understood that, when the child is in position on the high-chair 1, on account of its weight, the feeler 29 is tipped over in low position with the result that it exerts pressure on the contactor 35. The latter thus closes a circuit making it possible to send a signal to the microcontroller 23b which enables the latter to take into account the presence of the child on the high-chair.

Obviously it is possible, according to the invention, to resort to any other type of presence sensor and notably to a piezo type sensor 37 as represented schematically in FIG. 10. In this figure the sensor is constituted of a casing 37a enclosing a piezo crystal cartridge 37b and of which the front part is provided with a feeler 37c which, when no stress is exerted thereon, overshoots the upper part of the casing 37a. Said feeler 37c is mechanically connected to a rigid transmission element 37d with the piezo cartridge 37b, in such a way that, when a bearing force is exerted thereon, in the direction of arrow A in FIG. 10, the piezo cartridge 37b is compressed and generates a pulse which is communicated, via communication means, notably of wire type, to the microcontroller 23b. On reception the latter takes into account the presence of a child on the seat 1.

In an alternative of the invention it is also possible to constitute a child presence detector by means of a capacitive antenna arranged in a casing which could be positioned under the seat base 3a of the high-chair as well as the casing 23 mentioned previously and represented in FIG. 1.

Such an alternative of the invention is particularly interesting in that it does not require any modification of the high-chair for its implementation. This capacitive antenna will be furthermore suitable for detecting the presence of the child through the material of the seat base 3a whether it is notably made of wood or made of a synthetic material. The capacitive antenna measurement could take place at a distance and, depending on the adjustment of the parameters thereof, it will be able to diagnose, on the one hand the presence or not of a child in the high-chair and on the other hand smaller variations corresponding to the fact that the child has raised itself slightly, for example by a centimetre, even though its presence is detected, which will participate with the means implemented for the detection of shaking as described hereafter. Thus a capacitive antenna indeed constitutes a means for detecting and measuring a level of shaking by the occupant of the seat.

As regards the means for detecting the first signs of a fall, the high-chair 1 is thus equipped with shaking detection means.

In an exemplary embodiment of these means for detecting shaking by the occupant of the high-chair, at least one accelerometer 34, of three-dimensional type, is arranged for example under the seat base 3a thereof, notably in the casing 23, which is connected to the microcontroller 23b, and is able to detect any untimely movement of the high-chair, that is to say any sudden movement reflecting a considerable agitation of the child which, if it were to continue, could lead to the high-chair purely and simply tipping over.

The accelerometer 34 is arranged in such a way that, as represented in FIG. 1, its x axis is positioned towards the front of the high-chair 1, its y axis is positioned transversally thereto and its axis z is positioned vertically.

The shaking detection means could include adjustment means making it possible, notably during initialisation, to correct by means of software potential positioning errors.

The detection of shaking may take place continuously with a measurement frequency of the order for example of 100 times per second. Thus, in a first example of the invention, the microcontroller 23b performs a series of N measurements of the acceleration, for example of the order of 10 to 20 measurements, and preferentially 16, along each of the three axes x, y, z. This will thus give the following measurements:

[symbol]

ₓ₁, [symbol] ₓ₂, . . . [symbol] ₓₙ

[symbol]

_{y1}, [symbol] _{y2}, . . . [symbol] _{yn}

[symbol]

_{z1}, [symbol] _{z2}, . . . [symbol] _{zn},

Then the microcontroller 23b computes an average [symbol] ₓₘ, [symbol] _{ym}, [symbol] _{zm} of these different measurements and this gives:

[symbol]

ₓₘ=( [symbol] ₓ₁+ [symbol] ₓ₂− . . . + [symbol] ₓₙ)/N

[symbol]

_{ym}=( [symbol] _{y1}+ [symbol] _{y2}+ . . . + [symbol] _{yn})/N

[symbol]

_{zm}( [symbol] _{z1}+ [symbol] _{z2}+ . . . − [symbol] _{zn})/N

and it next calculates, for each of the axes x, y, z, the mean deviation bx, b_{y}, bz, that is to say the average of the absolute value of the deviation of each of these measurements with this average value.

δₓ=(| [symbol] ₓ₁− [symbol] ₓₘ|+| [symbol] ₓ₂− [symbol] ₓₘ|+ . . . +| [symbol] ₓₙ− [symbol] ₓₘ|)/N

δ_{y}=(| [symbol] _{y1}− [symbol] _{ym}|+| [symbol] _{y2}− [symbol] _{ym}|+ . . . +| [symbol] _{yn}− [symbol] _{ym}|)/N

δ_{z}=(| [symbol] _{z1}− [symbol] _{zm}|+| [symbol] _{z2}− [symbol] _{zm}|+ . . . +| [symbol] _{zn}− [symbol] _{zm}|)/N

This mean deviation value δₓ, δ_{y}, δ_{z} is thus representative of the movements made by the occupant of the high-chair 1 along each of the three axes x, y, z. These values characteristic of the level of shaking along the three axes x, y, z are thus interesting in that they enable the microcontroller 23b, via appropriate management software, to be able to take into consideration very diverse dangerous situations.

It will thus be understood that when the high-chair 1 is immobile, the mean deviation will be of the order of the measurement noise of the accelerometer 34, that is to say of the order of +/1 to 2 bits, that is to say the bits of low weight of the measurement contained in the registers of the accelerometer 34 which constitutes a first threshold value.

If said value is exceeded, the microcontroller 23b detects a higher threshold value which corresponds to a non-immobile state of the high-chair 1 and then sets off the signalling means. A higher threshold will enable the microcontroller 23b to determine the difference between a normal level of shaking corresponding to the presence of an occupant in the high-chair and a much higher alarming level of shaking.

The present invention makes it possible to detect for example a situation in which a person and notably a child displaces the high-chair with a child already present without such a displacement modifying its inclination since, in such a situation, the mean deviation value along the z axis, i.e. the value δ_{z}, will be low or even inexistent and that the values δₓ and δ_{y} will have high values characteristic of the displacement of the high-chair in a plane.

To improve the predominance of shaking in the horizontal plane characterising a displacement of the high-chair 1 without tipping over, the microcontroller will compare the shaking in the horizontal plane equal to the square root of the two shakings along the x and y axes with that of the vertical z axis. If the shaking in the horizontal plane is much greater, for example three times greater, than the shaking along the vertical axis, the microcontroller 23b will favour a lateral displacement.

These shaking detection means are also able to detect a situation in which the high-chair 1 being empty, a child attempts to climb into the latter, and to do so well before the detection means of a variation in inclination of the chair has reacted. In fact, in such a situation, when the high-chair is provided with presence detection means any shaking of the chair predominant in the plane will establish such a situation.

In another embodiment of the means for detecting shaking by the occupant of the high-chair, more precise means will be used for analysing the N samples of measurements carried out. Instead of a simple determination of a mean deviation, a method will be used, well known per se, namely the so-called least squares method, to define the linear function coming the closest to the physical measurement of the N samples:
the distance to the linear regression line will be the measurement of the shaking along one of the axes,
the slope of the linear regression line will characterise, if it is low, a simple translation and, if the slope is high, a significant increase/decrease in the successive values diagnosing the combination of a shaking and a rotation leading to a monotonous increasing/decreasing variation of the acceleration values.

When shaking above a threshold level is detected the microcontroller 23b then sets off an alarm via its warning means. The latter may be constituted, in a simple embodiment as mentioned previously, by the buzzer 23d or, in a more sophisticated embodiment, the alert may be relayed by a local signal, by an audible and/or visual signal sent on a remote RF receiver, or an intelligent terminal of smartphone type as well as on any apparatus equipped with Bluetooth technology, notably of low energy type, or any other information transmission standard, and notably a hi-fi chain, a computer, a television, an autonomous loudspeaker, etc.

Furthermore, in certain collective surveillance contexts, for example of kindergarten type, it is possible to implement a solution by transponder or antenna analogous to anti-theft systems. In the absence of alert, the transponder is enclosed in a metal housing which acts as a Faraday cage. In the event of alert or alarm one of the faces of the housing is physically open enabling the detection of the transponder. The solution by flat antenna is also possible, the antenna facing or not a metal cover preventing the detection of the antenna analogous to anti-theft systems.

Obviously according to the invention it is possible to create a redundancy of sensors making it possible to improve the safety of the system.

The present invention also takes into account the situation in which the high-chair begins to tip over and proposes means able to detect a variation in the inclination thereof.

Resort may thus be made to an inclinometer 36 arranged on the seat, for example under the seat base 3a thereof notably in the casing 23, as represented in FIG. 4, which will send to the microcontroller 23b the value I of instantaneous inclination of the seat. On reception, the microcontroller 23b will compare this value I with a limit reference value I₁ and if said value is reached it will then set off an alarm procedure.

Obviously, it could be possible in an interesting manner to combine the use both of the accelerometer detecting shaking by the occupant and the inclinometer detecting an inclination of the chair, so as to be able to generate a progressive warning for the attention of the user.

Thus for example, if the occupant of the high-chair 1 begins to move about, without however this shaking being sufficient to bring about an inclination of the seat, said shaking will however be detected by the accelerometer 34 and sent to the microcontroller 23b which, via the warning means, will emit a specific signal characteristic of simple shaking, either by the buzzer 23d or by means of a vocal signal.

It is also possible according to the invention to provide, notably for pedagogic purposes, to implement means suitable for emitting a pre-alert, for example in the form of an ultrasound emission, that only the child could hear, and to do so before the emission of the warning intended to alert the user. Then, if the shaking by the occupant becomes such that it causes an inclination of the high-chair, this will then be detected by the inclinometer and sent to the microcontroller 23b which, via the warning means, will then emit another signal characteristic of an inclination of the seat. The user will thus be warned of the first signs of a serious and imminent risk of a fall from the high-chair.

Obviously, according to the invention the inclinometer function may be ensured, in a known manner, by an accelerometer and notably a three-axis accelerometer or by an inclinometer of the type using one or more gyroscopes.

The safety seat according to the invention could comprise analysis means constituted notably of electronic means including for example logic gates or means constituted of a microcontroller which will carry out this type of analysis by software means.

The analysis means could, as an example, detect various configurations that present a danger and notably the following cases:
A older child who climbs up or hangs from the high-chair when a child is already installed therein with the risk of making it topple over is diagnosed by the detection of the level of shaking mainly in a lateral y axis, by an accelerometer, whereas there is a child seated and strapped in detected by the presence detection means,
A child of which the high-chair is arranged near to a table and which pushes it away from the table with the risk of making it tip over is identified by the detection of a level of shaking mainly along the longitudinal y axis and the variations in angle of inclination of the high-chair by the accelerometers,
A child who is on the high-chair and who is standing on it with the risk of making it tip over is diagnosed by the detection that there is a child strapped in but not seated,
A child who is incorrectly strapped in or who has detached itself and is attempting to get out of the high-chair with the risk of making it tip over is diagnosed by the detection of a level of shaking and the detection of incorrect strapping in, notably at the level of the shoulder by the detection means of correct strapping in as described with regard to FIGS. 6 to 8.
A child who is incorrectly strapped in and who risks sliding and being strangled is diagnosed by the detection of a level of shaking and the detection of incorrect strapping in, notably at the level of the crotch strap, by the detection means of the type described with regard to FIGS. 1 to 4.

It could also be possible according to the invention to provide the activation and/or the deactivation of the system by the detection of hand gestures of the occupant of the seat by means for example of a capacitive antenna integrated in the casing or providing the automatic activation at the moment when the presence of the crotch straps is detected, finalising the putting in place of the occupant.

1-14. (canceled)

15. A safety seat comprising a seat base that is kept at a distance from the ground by support means, the safety seat comprising:
detection means and signalling means, the signalling means being able to go off when said safety seat is shaken above a threshold level, said detection means including at least one accelerometer;
means suitable for carrying out, with a given frequency, a series of (N) measurements of the acceleration undergone by said safety seat, along the measurement axes (x, y, z) of the accelerometer;
means suitable for calculating, for each of the measurement axes (x, y, z), an average acceleration value;
means suitable for calculating, for each of the measurement axes, a mean deviation corresponding to an average of the absolute value of the deviation of each measurement with the average acceleration value;
means suitable for comparing the mean deviation for each of the measurement axes (x, y, z) with a threshold value, and
means suitable for activating the signalling means when the mean deviation is at least equal to the threshold value.

16. The safety seat according to claim 15, wherein the detection and signalling means are in relation with a central system which manages the values read by said detection and signalling means.

17. The safety seat according to claim 16, wherein the central system comprises means suitable for comparing the components of the acceleration value supplied by the accelerometer with a threshold value and means suitable for activating the signalling means when the value becomes at least equal to said threshold value.

18. The safety seat according to claim 15, wherein the detection means include at least one capacitive sensor.

19. The safety seat according to claim 18, wherein the capacitive sensor is arranged in such a way that the capacitive sensor is suitable for detecting on the one hand the presence of an occupant on the seat and on the other hand a modification of the position of the occupant thereon.

20. The safety seat according to 15, wherein the detection means include at least one inclinometer.

21. The safety seat according to claim 16, wherein the detection means include at least one inclinometer and wherein the central system comprises means suitable for comparing an inclination value supplied by the inclinometer with at least one threshold value and means suitable for activating the signalling means when the value becomes at least equal to said threshold value.

22. The safety seat according to claim 15, wherein the signalling means are of audio type and/or of luminous type and/or of electronic type implementing transmission means of Bluetooth type to any apparatus compatible with this technology.

23. The safety seat according to claim 15, comprising a retaining harness provided with at least one lateral strap and one crotch strap of which a first end terminates in a locking buckle with at least one lateral strap, wherein the second end of the crotch strap passes through the seat base via a passage opening and extends by return means suitable for exerting a return force thereon tending to apply the buckle against the seat base.

24. The safety seat according to claim 23, wherein the return means are constituted of an elastic strap element made integral with the crotch strap at one of its ends and an attachment point of the seat at its other end.

25. The safety seat according to claim 23, further comprising, near to the passage opening, a proximity sensor of the buckle able to detect a presence thereof when it is applied against the seat base under the action of the return means.

26. A safety seat comprising a seat base that is kept at a distance from the ground by support means, the safety seat comprising:
detection means and signalling means, the signalling means being able to go off when said safety seat is shaken above a threshold level, said detection means including at least one accelerometer;
means suitable for carrying out, with a given frequency, a series of (N) measurements of the acceleration undergone by said safety seat, along the measurement axes (x, y, z) of the accelerometer;
means suitable for establishing a linear regression line for at least one of the measurement axes (x, y, x) from measurements of the acceleration undergone by said safety seat for said at least one axis using the least squares method;
means suitable for measuring the distance between the linear regression line and the measurements of the acceleration undergone by said safety seat for said at least one axis, said measured distance corresponding to a shaking of the seat along said at least one axis, and
means suitable for activating the signalling means when the measured distance is above a threshold value.

27. The safety seat according to claim 15, wherein the accelerometer is a three-dimensional accelerometer.

28. The safety seat according to claim 23, wherein the signalling means are a vibrator or a buzzer, or a flash or a LED, wherein the transmission means is a low energy transmission means and wherein the apparatus is a smartphone and/or a computer and/or an autonomous loudspeaker and/or a television.

29. The safety seat according to claim 26, wherein the accelerometer is a three-dimensional accelerometer.
